(19) United States
(12) Patent Application Publication
(10) Pub. No.: US 2022/0325146 A1
(43) Pub. Date: Oct. 13, 2022

(54) PACKAGING POLYMERS

(71) Applicant: REXTAC LLC, Odessa, TX (US)

(72) Inventors: James Nicholas Fowler, Odessa, TX (US); John Joseph Decair, Odessa, TX (US); Andres Sustic, Odessa, TX (US)

(21) Appl. No.: 17/720,208

(22) Filed: Apr. 13, 2022

Related U.S. Application Data
(60) Provisional application No. 63/174,104, filed on Apr. 13, 2021.

(51) Int. Cl. C09J 123/12; B65D 75/46

(52) U.S. Cl. CPC C09J 123/12; B65D 75/46; B29B 9/06

(57) ABSTRACT

A packaging material including a polymeric film surrounding a plastic mass form material. In embodiments, methods include packaging sticky plastic mass form polymers within a polymeric film to prevent agglomeration. Processes include the use of a polymeric film composition that is compatible with the core plastic mass form. The polymeric film can be applied to the plastic mass form through continuous coextrusion, as a film through a hot melt form, fill, and seal process, or as a sealed film bag for inclusion of cooled and coated or uncoated solid sticky plastic material shapes.

### CROSS REFERENCE TO RELATED APPLICATIONS

The present application claims priority to and the benefit of U.S. Prov. Pat. App. Ser. No. 63/174,104, which was filed on Apr. 13, 2021, which to the extent that it is consistent with the present disclosure is hereby incorporated herein by reference in its entirety and to the extent that is not inconsistent with the present disclosure.

### BACKGROUND

### Technical Field

The present disclosure generally relates to polymers for packaging. In particular, the present disclosure relates to adhesive polymers.

### Description of the Related Art

Hot melt adhesives may generally be provided in the form of pellets that have a tacky core, giving them a propensity to stick together during manufacture, transport, and/or storage. Agglomeration of hot melt adhesive pellets may cause complications in handling and processing, thereby increasing associated labor and equipment costs.

### SUMMARY

One embodiment of the present disclosure comprises a package. The package comprises a plastic mass form core having a finite size and shape and a polymeric film surrounding the plastic mass form core. The polymeric film has a composition comprising: between 5% and 80% by weight, inclusive, of a metallocene catalyzed propylene-based polymer with a melt viscosity greater than 500 centipoise (“cP”) at 190° C.; between 20% and 50% by weight, inclusive, of a hydrocarbon, non-Fischer-Tropsch wax material; less than 75% by weight of a metallocene catalyzed propylene-ethylene co-polymer having a viscosity of greater than 500 cP at 190° C.; less than 75% by weight of a metallocene catalyzed ethylene-based co-polymer having a viscosity of greater than 500 cP at 190° C.; 5% or less by weight of a Ziegler-Natta catalyzed amorphous poly alpha olefin; 5% or less by weight of a metallocene catalyzed amorphous poly alpha olefin; between 0.001% and 1% by weight, inclusive, of an antioxidant; and 5% or less by weight of a non-Fischer-Tropsch wax dust on one or more exterior surfaces of the polymeric film. The polymeric film has an enthalpy of fusion of less than 100 J/g as measured in accordance with test method ASTM D-3417, as promulgated by ASTM International.

Another embodiment of the present disclosure comprises a polymeric film. The polymeric film has a composition comprising between 5% and 80% by weight, inclusive, of a metallocene catalyzed propylene-based polymer with a melt viscosity greater than 500 centipoise (“cP”) at 190° C.; between 20% and 50% by weight, inclusive, of a hydrocarbon, non-Fischer-Tropsch wax material; less than 75% by weight of a metallocene catalyzed propylene-ethylene co-polymer having a viscosity of greater than 500 cP at 190° C.; less than 75% by weight of a metallocene catalyzed ethylene-based co-polymer having a viscosity of greater than 500 cP at 190° C.; 5% or less by weight of a Ziegler-Natta catalyzed amorphous poly alpha olefin; 5% or less by weight of a metallocene catalyzed amorphous poly alpha olefin; between 0.001% and 1% by weight, inclusive, of an antioxidant; and 5% or less by weight of a non-Fischer-Tropsch wax dust. The polymeric film has an enthalpy of fusion of less than 100 J/g as measured in accordance with test method ASTM D-3417, as promulgated by ASTM International.

Another embodiment of the present disclosure comprises a method of producing a hot melt adhesives pellet. The method comprises forming a polymeric film intermediate, melting the polymeric film intermediate into a molten state, coextruding the polymeric film intermediate with a plastic mass core, thereby producing a strand of plastic mass core enveloped within polymeric film, cooling the strand, and cutting the strand into pellets as the strand cools. The polymeric film intermediate is formed by blending together the following compositions: between 5% and 80% by weight, inclusive, of a metallocene catalyzed propylene-based polymer with a melt viscosity greater than 500 centipoise (“cP”) at 190° C.; between 20% and 50% by weight, inclusive, of a hydrocarbon, non-Fischer-Tropsch wax material; less than 75% by weight of a metallocene catalyzed propylene-ethylene co-polymer having a viscosity of greater than 500 cP at 190° C.; less than 75% by weight of a metallocene catalyzed ethylene-based co-polymer having a viscosity of greater than 500 cP at 190° C.; 5% or less by weight of a Ziegler-Natta catalyzed amorphous poly alpha olefin; 5% or less by weight of a metallocene catalyzed amorphous poly alpha olefin; between 0.001% and 1% by weight, inclusive, of an antioxidant; and 5% or less by weight of a non-Fischer-Tropsch wax material.

### DETAILED DESCRIPTION

Before explaining the present process in detail, it is to be understood that the process is not limited to the particular embodiments and that it can be practiced or carried out in various ways.

Embodiments of the present disclosure include packages and polymers for packaging. In some embodiments, the packaging comprises a core plastic mass form and an exterior polymeric film. In some embodiments, the plastic mass form is a sticky and adhesive plastic core comprising a sticky polymer or hot melt adhesive in a plurality of shapes and sizes surrounded by the polymeric film. The term “sticky,” as used herein, means the material of the plastic mass form has a coefficient of static friction greater than 0.0612. Embodiments of the polymeric film comprise a non-adhesive polymeric film configured to protect the form from agglomerating with other packages and/or other objects. In some embodiments, an internal polymeric film is incorporated into internal-facing surfaces of the plastic mass form, such that the internal polymeric film can protect contents of the package from adhering to the plastic mass form.

According to various embodiments of the present disclosure, the polymeric film composition is compatible with the plastic forms in such a way that the polymeric film can be incorporated onto the sticky plastic material of the plastic form by joining and remelting. According to embodiments, the polymeric film and plastic form are heated to a molten state while enclosing the plastic form within the polymeric film, thereby combining the plastic form material with the polymeric film into a single mass. According to various embodiments, the polymeric film may envelop the plastic form without substantially reducing the adhesive properties of the plastic form. In the present disclosure, the term “substantially reduce” means a reduction of at least five percent of the original property.

Further, embodiments of the polymeric film may envelop the plastic form without adversely affecting other material properties of the plastic form, such as viscosity, workability, color, and odor. A polymeric film may be compatible with a plastic form if the polymeric film melts at a temperature consistent with the melt temperature of the plastic form material.

In some embodiments, the polymeric film can be applied to the polymer or hot melt adhesive through continuous coextrusion. In other embodiments, the polymeric film can be applied as a film through a hot melt form, fill, and seal process. In some embodiments, the polymeric film can be applied as a sealed film bag for inclusion of cooled and coated or uncoated solid sticky plastic material shapes.

According to various embodiments of the present disclosure, shapes of a package may be produced by coextruding and enveloping a plastic mass form within a non-adhesive polymeric film. In other embodiments, shapes of a package may be produced by hot filling, enveloping, and sealing a plastic mass form within a formed non-adhesive polymeric film wrapper. In other embodiments, shapes of a package may be produced by sealing grouped coated or uncoated individual shapes of cooled plastic forms within a non-adhesive polymeric film bag.

In embodiments of the present disclosure, the polymeric film composition does not substantially reducing the adhesive properties of the contained plastic form. In one example embodiment, the polymeric film comprises between 5% and 80% by weight, inclusive, of a metallocene catalyzed propylene-based polymer that has a melt viscosity greater than 500 centipoise (“cP”) at 190° C. Throughout the present disclosure, references to melt viscosity is as measured in accordance with test method ASTM D-3236 as promulgated by ASTM International. In this example embodiment, the polymeric film also comprises between 20% and 50% by weight, inclusive, of a hydrocarbon, non-Fischer-Tropsch wax material. In this example embodiment, the polymeric film also comprises less than 75% by weight metallocene catalyzed propylene-ethylene co-polymer having a viscosity of greater than 500 cP at 190° C. In this example embodiment, the polymeric film also comprises less than 75% by weight metallocene catalyzed ethylene-based co-polymer having a viscosity of greater than 500 cP at 190° C. In this example embodiment, the polymeric film also comprises 5% or less by weight Ziegler-Natta catalyzed amorphous poly alpha olefin. In this example embodiment, the polymeric film also comprises 5% or less by weight metallocene catalyzed amorphous poly alpha olefin. In this example embodiment, the polymeric film also comprises between 0.001% and 1% by weight, inclusive, antioxidant. In this example embodiment, the polymeric film also comprises 5% or less by weight non-Fischer-Tropsch wax dust on one or more exterior surfaces of the polymeric film. According to this example embodiment, the polymeric film has an enthalpy of fusion of less than 100 J/g as measured in accordance with test method ASTM D-3417.

As would be understood by a person of ordinary skill in the art having the benefit of the present disclosure, a composition's enthalpy of fusion may be measured using a Differential Scanning calorimetry (“DSC”) test method. A DSC test can be performed on film compositions in accordance with test method ASTM D-3417, as promulgated by ASTM International of West Conshohocken, Pa., with sweeping rates of 20° C. per minute on a DSC25 instrument from TA Instruments of New Castle, Del. Three temperature sweeps may be performed consecutively on a 5 to 10 mg sample under a nitrogen atmosphere from −80° C. to 200° C., then from 200° C. to −80° C., then again from −80° C. to 200° C. This last sweep may show a reproducible measurement of the enthalpy of fusion of the film composition expressed in Joules per gram of material. “Enthalpy of fusion” may sometimes be referred to as “melting capacity” and/or “specific heat capacity” by those skilled in the art.

In some embodiments, the polymeric film comprises a thickness in the range of 10 to 2,500 microns, inclusive. In various embodiments, the plastic form comprises a material selected from the group consisting of a thermoplastic polymer, a thermoplastic compound, a thermoplastic composition, a hot melt adhesive polymer, a hot melt adhesive composition, a hot melt adhesive compound, and blends thereof.

In one embodiment, a plastic mass form is simultaneously coextruded as a core plastic mass form enveloped within the polymeric film. In some cases, this polymeric film is in a molten state. Following this simultaneous coextrusion, the plastic mass form and polymeric film can be cooled and cut to enclose the plastic mass form within the polymeric film. In some embodiments, the polymeric film coats more than 90% of the core plastic mass form surface.

According to various embodiments of the present disclosure, a polymeric film is independently produced by blending a metallocene catalyzed propylene-based polymer, a hydrocarbon, non-Fischer-Tropsch wax material, a metallocene catalyzed ethylene-based copolymer, and an antioxidant. In one embodiment, the polymeric film is subsequently shaped into a continuous tube, and then simultaneously filled with the molten plastic mass form and cooled. Following cooling, the polymeric film can be sealed and cut into individual packages.

According to some embodiments, the polymeric film and plastic mass form are coextruded together as a long strand and dropped into a cooling water bath. A rotating cutting wheel having sharp knives and/or edges may be used to cut the strand into pellets of desired lengths. The pellets can then float down a water channel while continuing to cool.

In one embodiment, the polymeric film is first independently produced, and the plastic mass form is independently formed into individual finite shapes. Subsequently, the individual finite shapes are then cooled to below the melting point of the polymeric film. Individual finite shapes may then be collected in finite groups and enclosed and sealed within individual bags formed from the independently produced polymeric film.

In some embodiments, the plastic mass form comprises a sticky adhesive with a tendency to agglomerate with itself or other objects. In various embodiments, uncoated and rounded shaped particles, made of the same material as the plastic mass form, possess a coefficient of static friction greater than 0.0612. In some embodiments, the plastic mass form has a mass between 3 grams and 2,000 grams, inclusive.

In one embodiment, the produced package can be conveyed via mechanical or pneumatic means. In such embodiments, the produced package comprises an exterior shape, and material strength sufficient to undergo conditions typical to such conveyance systems. In some examples, a mechanical means of conveyance includes a conveyor belt or a vibrating conveyor. In other examples, such a pneumatic means includes a pneumatic tube transport system. In embodiments, the produced package comprises flexible packaging material.

### Prophetic Example—Polymeric Film

An exemplary method to make a polymeric film surrounding a plastic mass form is described. A first step involves blending, by any of the known means of preparing blends of hydrocarbon polymeric molecules, about between 45% by weight of a metallocene catalyzed propylene-based polymer with a melt viscosity greater than 500 cP at 190° C., about 20% by weight of a hydrocarbon, non-Fischer-Tropsch wax material, about 15% by weight of a metallocene catalyzed propylene-ethylene co-polymer having a viscosity of greater than 500 cP at 190° C., about 15% by weight of a metallocene catalyzed ethylene-based co-polymer having a viscosity of greater than 500 cP at 190° C., about 2% by weight of a Ziegler-Natta catalyzed amorphous poly alpha olefin, about 2.9% of a metallocene catalyzed amorphous poly alpha olefin and about 0.1% of an antioxidant.

It is theorized that such a polymeric film composition would have a melt viscosity greater than 500 cP at 190° C. and an enthalpy of fusion of less than 100 J/g.

### Working Example 1—Intermediate

An intermediate of a polymeric film surrounding a plastic mass form was prepared by blending about 50% by weight of a metallocene catalyzed propylene-based polymer that has a melt viscosity greater than 500 cP, about 25% by weight of a hydrocarbon, non Fischer-Tropsch wax, and about 25% by weight of a metallocene catalyzed ethylene-based copolymer having a melt viscosity greater than 500 cP at 190° C. This intermediate was tested as having a melt viscosity greater than 500 cP at 190° C. and an enthalpy of fusion of less than 100 J/g.

### Working Example 2—Intermediate

An intermediate of the polymeric film surrounding the plastic mass form was prepared by blending about 65% by weight of a metallocene catalyzed propylene-based polymer that has a melt viscosity greater than 500 cP, about 25% by weight of a hydrocarbon, non Fischer-Tropsch wax, and about 10% by weight of a metallocene catalyzed propylene-ethylene copolymer having a melt viscosity greater than 500 cP at 190° C. This intermediate was tested as having a melt viscosity greater than 500 cP at 190° C., and an enthalpy of fusion of less than 100 J/g.

### Working Example 3—Intermediate

An intermediate of the polymeric film surrounding the plastic mass form was prepared by blending about 64.5% by weight of a metallocene catalyzed propylene-based polymer that has a melt viscosity greater than 500 cP, about 28% by weight of a metallocene catalyzed propylene-ethylene copolymer having a melt viscosity greater than 500 cP at 190° C., about 5% of a metallocene catalyzed amorphous poly alpha olefin, about 2% by weight of a Ziegler-Natta catalyzed amorphous poly alpha olefin, and 0.5% by weight of an antioxidant. This intermediate was tested as having a melt viscosity greater than 500 cP at 190° C. and an enthalpy of fusion of less than 100 J/g.

While these embodiments have been described with emphasis on the embodiments disclosed, it should be understood that within the scope of the appended claims, the embodiments might be practiced other than as specifically described herein.

What is claimed is:

1. A package, comprising:
a plastic mass form core having a finite size and shape; and
a polymeric film surrounding the plastic mass form core, the polymeric film having a composition comprising:
between 5% and 80% by weight, inclusive, of a metallocene catalyzed propylene-based polymer with a melt viscosity greater than 500 centipoise (“cP”) at 190° C., as measured in accordance with test method ASTM D-3236;
between 20% and 50% by weight, inclusive, of a hydrocarbon, non-Fischer-Tropsch wax material;
less than 75% by weight of a metallocene catalyzed propylene-ethylene co-polymer having a viscosity of greater than 500 cP at 190° C.;
less than 75% by weight of a metallocene catalyzed ethylene-based co-polymer having a viscosity of greater than 500 cP at 190° C.;
5% or less by weight of a Ziegler-Natta catalyzed amorphous poly alpha olefin;
5% or less by weight of a metallocene catalyzed amorphous poly alpha olefin;
between 0.001% and 1% by weight, inclusive, of an antioxidant; and
5% or less by weight of a non-Fischer-Tropsch wax dust on one or more exterior surfaces of the polymeric film;
wherein the polymeric film has an enthalpy of fusion of less than 100 J/g as measured in accordance with test method ASTM D-3417, as promulgated by ASTM International.

2. The package of claim 1, wherein the polymeric film has a thickness of 10 to 2500 microns, inclusive.

3. The package of claim 1, wherein the plastic mass form core comprises a material selected from the group consisting of a thermoplastic polymer, a thermoplastic compound, a thermoplastic composition, a hot melt adhesive polymer, a hot melt adhesive composition, a hot melt adhesive compound, and blends thereof.

4. The package of claim 1, wherein the plastic mass form core is produced by:
simultaneously coextruding a core enveloped within the polymeric film to form a hot strand while the polymeric film is in a molten state, and
cooling and cutting the hot strand to form a pellet.

5. The package of claim 4, wherein the pellet comprises the polymeric film coating more than 90% of the plastic mass form core exterior surface.

6. The package of claim 1, wherein the polymeric film was:
produced independently from the plastic mass form core;
shaped into a continuous tube;
then simultaneously filled with the plastic mass form core while the plastic mass form core was molten;
then cooled; and
then sequentially sealed and cut into individual packages.

7. The package of claim 6, wherein the polymeric film coats more than 90% of the plastic mass form core surface.

8. The package of claim 1, wherein:
the polymeric film is produced independently from the plastic mass form core; and
the plastic mass form core is:
formed into individual finite shapes;
cooled to below the melting point of the polymeric film;
collected in finite groups; and
each enclosed and sealed within individual bags formed from the polymeric film.

9. The package of claim 1, wherein material of the plastic mass form core possesses a coefficient of static friction greater than 0.0612 when made into particles that are round and uncoated.

10. The package of claim 1, wherein the package is able to be conveyed via a pneumatic tube transport system, a conveyor belt, or a vibrating conveyor.

11. A polymeric film having a composition comprising:
between 5% and 80% by weight, inclusive, of a metallocene catalyzed propylene-based polymer with a melt viscosity greater than 500 centipoise (“cP”) at 190° C., as measured in accordance with test method ASTM D-3236;
between 20% and 50% by weight, inclusive, of a hydrocarbon, non-Fischer-Tropsch wax material;
less than 75% by weight of a metallocene catalyzed propylene-ethylene co-polymer having a viscosity of greater than 500 cP at 190° C.;
less than 75% by weight of a metallocene catalyzed ethylene-based co-polymer having a viscosity of greater than 500 cP at 190° C.;
5% or less by weight of a Ziegler-Natta catalyzed amorphous poly alpha olefin;
5% or less by weight of a metallocene catalyzed amorphous poly alpha olefin;
between 0.001% and 1% by weight, inclusive, of an antioxidant; and
5% or less by weight of a non-Fischer-Tropsch wax dust;
wherein the polymeric film has an enthalpy of fusion of less than 100 J/g as measured in accordance with test method ASTM D-3417, as promulgated by ASTM International.

12. The polymeric film of claim 11, wherein the polymeric film has a thickness of 10 to 2500 microns, inclusive.

13. The polymeric film of claim 11, wherein the polymeric film coats more than 90% of a plastic mass form exterior surface.

14. The polymeric film of claim 11, wherein the polymeric film is produced by simultaneously coextruding the polymeric film with a plastic mass core while the polymeric film is in a molten state, thereby producing a strand of plastic mass core enveloped within the polymeric film.

15. The polymeric film of claim 14, wherein the polymeric film is further produced by cooling and cutting the strand, thereby producing a pellet.

16. The polymeric film of claim 15, wherein the polymeric film coats more than 90% of the exterior surface of the pellet.

17. A method of producing a hot melt adhesives pellet, comprising:
blending together, to form a polymeric film intermediate, the following compositions:
between 5% and 80% by weight, inclusive, of a metallocene catalyzed propylene-based polymer with a melt viscosity greater than 500 centipoise (“cP”) at 190° C., as measured in accordance with test method ASTM D-3236;
between 20% and 50% by weight, inclusive, of a hydrocarbon, non-Fischer-Tropsch wax material;
less than 75% by weight of a metallocene catalyzed propylene-ethylene co-polymer having a viscosity of greater than 500 cP at 190° C.;
less than 75% by weight of a metallocene catalyzed ethylene-based co-polymer having a viscosity of greater than 500 cP at 190° C.;
5% or less by weight of a Ziegler-Natta catalyzed amorphous poly alpha olefin;
5% or less by weight of a metallocene catalyzed amorphous poly alpha olefin;
between 0.001% and 1% by weight, inclusive, of an antioxidant; and
5% or less by weight of a non-Fischer-Tropsch wax material;
melting the polymeric film intermediate into a molten state;
coextruding the polymeric film intermediate with a plastic mass core, thereby producing a strand of plastic mass core enveloped within a polymeric film coating;
cooling the strand; and
cutting the strand into pellets as the strand cools.

18. The method of claim 17, wherein the polymeric film coating covers the pellet with a thickness of 10 to 2500 microns, inclusive.

19. The method of claim 17, wherein the plastic mass core comprises a material selected from the group consisting of a thermoplastic polymer, a thermoplastic compound, a thermoplastic composition, a hot melt adhesive polymer, a hot melt adhesive composition, a hot melt adhesive compound, and blends thereof.

20. The method of claim 17, wherein the polymeric film coating coats more than 90% of the plastic mass form exterior surface on each pellet.
